(19) United States
(12) Patent Application Publication
(10) Pub. No.: US 2023/0155768 A1
(43) Pub. Date: May 18, 2023

(54) LATENCY REDUCTION IN WIRELESS SYSTEMS WITH MULTI-LINK OPERATION

(71) Applicant: MAXLINEAR, INC., Carlsbad, CA (US)

(72) Inventor: Sigurd Schelstraete, Menlo Park, CA (US)

(21) Appl. No.: 18/052,932

(22) Filed: Nov. 6, 2022

Related U.S. Application Data
(60) Provisional application No. 63/263,632, filed on Nov. 5, 2021.

(51) Int. Cl. H04L 5/00; H04W 72/08; H04W 72/04; H04W 76/15

(52) U.S. Cl. CPC H04L 5/0048; H04W 72/085; H04W 72/0453; H04W 76/15

(57) ABSTRACT

Systems and methods for reducing latency in a multi-link device or system include assigning latency sensitive data to a first channel of a smaller width, as compared to a second channel that is to handle non-latency sensitive data.

### CROSS REFERENCE TO RELATED APPLICATIONS

This U.S. Patent Application claims priority to U.S. Provisional Pat. Application 63/263,632 filed on Nov. 5, 2021. The disclosure of this prior application is considered part of the disclosure of this application and is hereby incorporated by reference in its entirety.

### TECHNICAL FIELD

The embodiments discussed in the present disclosure are related to latency reduction in wireless systems with multi-link operation.

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi. Some Wi-Fi communications include multicast support where data transmission may be addressed to multiple receiving devices simultaneously. Additionally, some Wi-Fi communications may be broadcast over different radio links that may include varying operational frequencies.

Data transmitted over the network may experience delays and/or latency as the number of devices included in the network increase, the amount of data transmitted over the network increases, and/or combinations of an increased number of devices and data.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

One aspect of the disclosure provides a method for reducing latency in a multi-link device or system. The method includes mapping one or more latency sensitive services to multiple channels, obtaining data to be transmitted, the data including latency sensitive data and non-latency sensitive data, identifying a first channel of the multiple channels for the latency sensitive data, identifying a second channel of the multiple channels for the non-latency sensitive data, transmitting the latency sensitive data on the first channel, and transmitting the non-latency sensitive data on the second channel.

Another example method may include mapping one or more latency sensitive services to multiple channels of a multi-link device, the multiple channels including a first channel and a second channel, obtaining data to be transmitted, the data including latency sensitive data and non-latency sensitive data, at least some of the data being associated with a latency sensitive service of the one or more latency sensitive services, assigning at least a portion of the latency sensitive data to the first channel in view of an association to a latency sensitive service, and assigning the non-latency sensitive data to the second channel.

In an example, a multi-link device may include a memory and one or more processors operatively coupled to the memory. The one or more processors may be configured to execute operations including to obtain data to be transmitted, the data including latency sensitive data and non-latency sensitive data, assign at least a portion of the latency sensitive data to a first channel, and assign non-latency sensitive data to a second channel, the first channel having a smaller width than the second channel. The example multi-link device may include a first link and a second link, where the first channel is associated with the first link of the multi-link device, where the second channel is associated with the second link of the multi-link device. The example multi-link device may be configured to operate in a 320 MHz or greater system. The example multi-link device may include first channel being assigned based on an interference measurement related to the first channel.

### BRIEF DESCRIPTION OF THE DRAWINGS

Example embodiments will be described and explained with additional specificity and detail through the use of the accompanying drawings in which:

FIG. 1 illustrates a block diagram of an example system including two multi-link devices (MLDs);

FIG. 2 illustrates a block diagram of another example system including two MLDs;

FIGS. 3-4 illustrate flowcharts of example arrangements of operations for methods for latency reduction in MLD systems and while using multiple radio links; and

FIG. 5 is a schematic view illustrating a machine in the example form of a computing device within which a set of instructions, for causing the machine to perform any one or more of the methods discussed herein, may be executed.

### DETAILED DESCRIPTION

Wireless communications, such as those implementing the IEEE 802.11 protocol, may benefit from data transmission improvements such increased throughput and/or improved latency. IEEE 802.11be may include improvements such as extremely high throughput and/or improved worst case latency and jitter, when compared to prior IEEE 802.11 protocols. In some circumstances, IEEE 802.1 1be and Wi-Fi 7 may be used to describe the same protocol and may be used interchangeably.

In some circumstances, attempts to improve latency in wireless communications may include implementing restricted target wake time (rTWT). rTWT may include a reservation type service for wireless communications that may provide reserved service periods for a latency sensitive frame to be transmitted. In some instances, a frame may refer to a packet. The latency sensitive data may include any data or other information that may be time sensitive in transmission or reception (e.g., a system heartbeat, data used in subsequent decisions, video streaming, etc.). A latency sensitive service may include any service that has a timing element such that an increased latency may adversely affect the service or the operation thereof. In some circumstances, the implementation of rTWT may be optional such that one or more devices in a network may not assign service periods for latency sensitive frames. Alternatively, or additionally, in instances in which service periods are assigned for latency sensitive frames, some frames transmitted by one or more devices in a network may infringe the service periods for the latency sensitive frames.

Aspects of the present disclosure address these and other shortcomings with prior approaches by providing improved latency reduction techniques. Systems and methods for reducing latency in a multi-link device or system include assigning latency sensitive data to a first channel of a smaller width, as compared to a second channel that is to handle non-latency sensitive data.

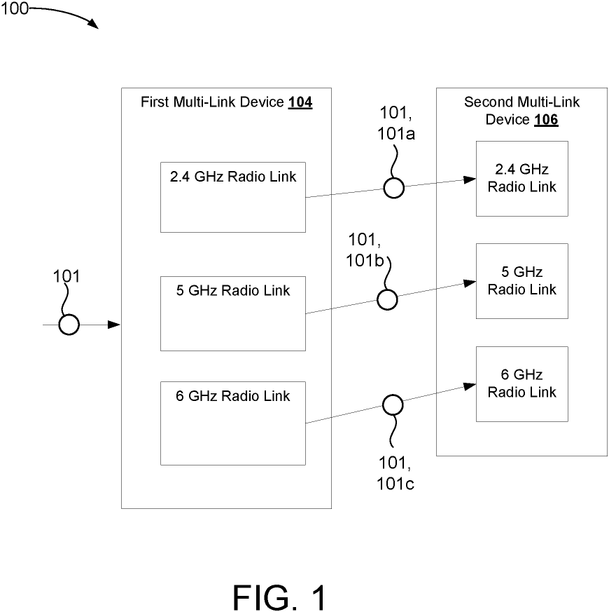

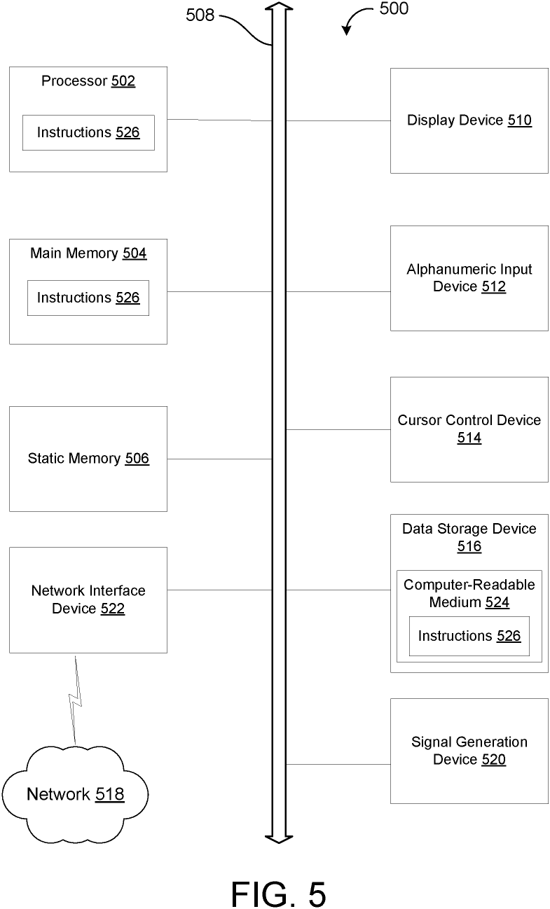

FIG. 1 illustrates a block diagram of an example system 100 including two multi-link devices (MLDs) 104, 106 in accordance with some implementations of this disclosure. In some implementations, the MLDs 104, 106 each include a computing device 500 of FIG. 5.

Multi-Link Operation (MLO) allows a MLD to operate concurrently over two or more links. Typically, each link is mapped to a channel and to a band. MLO may provide operation in different modes, such as using a single radio (e.g., multi-link single radio (MLSR), enhanced MLSR) or using two or more radios (e.g., simultaneous transmission and reception (STR), non-simultaneous transmission and reception (NSTR)).

As illustrated in FIG. 1, in some implementations, the MLD 104 includes an access point (e.g., an access point capable of handling multi-link devices) in data communication with the MLD 106, which may include a station or client that is multi-link capable. MLD 104 and MLD 106 may be in wireless communication (e.g., IEEE 802.11 standards) with each other. As shown, in some implementations, the MLD 104 is configured to transmit data 101 to the MLD 106. A multi-link capable device may include multiple links, such as different links that operate on different frequencies, each link being capable of handling traffic simultaneously with respect to the other links. For example, a multi-link capable device may include a 2.4 GHz radio link, a 5 GHz radio link, and/or a 6 GHz radio link and the multi-link capable devices may be configured to send and/or receive data over two or more radio links, simultaneously.

In a specific example, in some implementations, as shown, the MLDs 104 and 106 each include one or more radios (e.g., 2.4 GHz, 5 GHz, 6 GHz) such that the MLDs 104 and 106 may be configured to communicate with each other over radios, or radio pairs, of the same frequency. In some implementations, the MLD 104 is configured to transmit data 101 to the MLD 106 over more than one radio link. The MLD 106 is configured to receive the data 101 from the MLD 104 over more than one radio link. For example, as shown in FIG. 1, the MLD 106 may be configured to receive the data 101 via the 2.4 GHz radio link, the 5 GHz radio link, and the 6 GHz radio link. Other combinations of radio links transmitting data 101 may be possible including over fewer than all available radio links. For example, a MLD 106 may be configured to receive data 101 via the 2.4 GHz radio link and the 6 GHz radio link, or via the 2.4 GHz radio link and the 5 GHz radio link. The combinations of radio links and linked devices is illustrative only and not limiting.

The data 101 may include any type of data and may be associated with any type of service, including with a latency sensitive service. In some embodiments, the MLD 104 transmits identical data 101 over all links to provide redundancy and to ensure important data 101 reaches the MLD 106. In some embodiments, the MLD 104 may transmit the data 101 in subsets, such as in frames/packets. For example, a first subset 101a of the data may be transmit over a first link, a second subset 101b of the data may be transmit over a second link, and a third subset 101c of the data may be transmit over a third link. Further, some data may be transmitted redundantly, while other data 101 may not be transmitted redundantly, such as data 101a over the first link and the second link and data 101b over the third link.

One application of MLD includes bandwidth aggregation, allowing transmission at a higher peak rate between two MLD endpoints. For example, traffic may be multiplexed and sent from one device to another concurrently over multiple links. In this example, to use multiple links, the transmitting MLD 104 may independently contend for a medium on each of the links. In addition to aggregating bandwidth, this also provides the MLD with some benefit in latency. If the medium is occupied on one link, the MLD 104 may still be able to contend for a medium on another link to transmit data 101 on the another link, thereby gaining an advantage over a device that would only have access to a single link. A measurement of this advantage may depend on an overall loading of the network and a number of interfering devices/networks sharing a channel with the MLD (e.g., Overlapping BSS “OBSS”). As more devices and/or networks contend for a particular medium, transmissions may be delayed as they wait for the particular medium to become available while other networks have access. With MLO, the probability that multiple links or channels are busy at the same time is less than the probability of a single link or channel being busy, so MLO may provide some benefits in overall latency.

As mentioned above, each link is mapped to a channel and to a band. For example, in a system with two links and 160 MHz available bandwidth, each link may be mapped to a different channel, each channel having 80 MHz in width. The system 100 may have any amount of bandwidth available, including 20 MHz, 40 MHz, 80 MHz, 160 MHz, 240 MHz, 320 MHz, 640 MHz, 1280 MHz, 2560 MHz, or any other amount of bandwidth. Channels may be defined within the available bandwidth, including by defining multiple channels of equal width, or of non-equal width. Channels may be contiguous or non-contiguous, with any combination of width variations, such as 320/160+80+40+20+20 MHz, 240/160+40+20+20 MHz, 160/80+40+20+20, 80/40+20+20, or any other combination (where the number to the left of the “/” is the total available bandwidth and the numbers to the right of the “/” are various channel widths, where the channels are separated by “+”. Example bandwidth types to create the various combinations may include 20 MHz, 40 MHz, 80 MHz, 160 MHz, and 320 MHz. Further, less than all available bandwidth may be associated with a channel, for example, as in a 320/160 +20 configuration, a 160/80+20 configuration, etc.

The MLD 104 may be configured to multiplex data 101 over different channels, including over two 80 MHz channels. In some embodiments, a network including multiple MLDs may be configured to schedule an order for the multiple MLDs to transmit, over one or more channels included in the network. For example, the transmission order for the multiple MLDs may follow a round-robin schedule over one or more channels in the network.

In some embodiments, further modifying the system 100 may be advantageous to further optimize for latency reduction in a network. For example, the MLDs 104, 106 in the system 100 may be configured to include one smaller bandwidth channel, such as a 20 MHz channel, and one larger bandwidth channel, such as an 80 MHz channel, where both the smaller channel and the larger channel may include latency sensitive transmissions. In some embodiments, the smaller bandwidth channel (e.g., the 20 MHz channel) may be reserved for latency sensitive traffic and the larger bandwidth channel (e.g., the 80 MHz channel) may be utilized by non-latency sensitive traffic and/or latency sensitive traffic. In some embodiments, latency sensitive services may use either (or any) channel, but non-latency sensitive services are prevented from using specific channels.

Modifications, additions, or omissions may be made to the system 100 without departing from the scope of the present disclosure. For example, any number of MLDs may be used. Further, any number of links may be present on the MLDs. Moreover, as described, the first MLD 104 is described as a transmitter and the second MLD 106 is described as a receiver. Those roles may be reversed and the first MLD 104 may operate as a receiver and the second MLD 106 may operate as a transmitter. Other modifications, additions, or omissions may be made to the system 100 without departing from the scope of the present disclosure. For example, in some embodiments, the system 100 may include any number of other components that may not be explicitly illustrated or described.

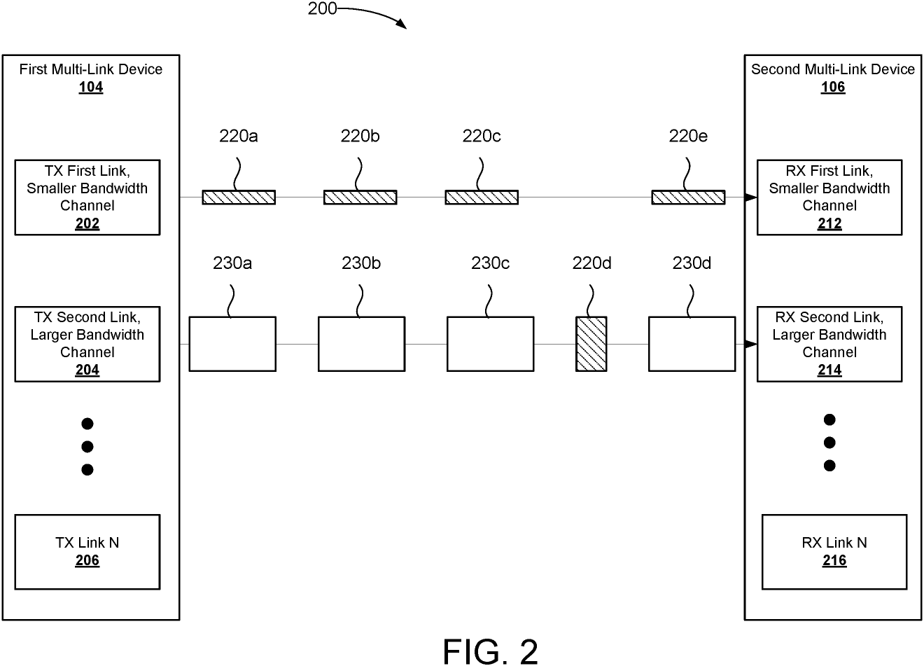

FIG. 2 illustrates a block diagram of an example system 200 including two MLDs 104, 106 in accordance with some implementations of this disclosure. The example system 200 may use MLD specifically to optimize latency associated with data transmission. For example, data may be associated with a service and the system 200 may be used to optimize latency of a particular service while also minimizing the amount of additional spectrum used. Instead of using more spectrum than is needed, for example, a more limited amount of bandwidth may be reserved for use with latency sensitive data (including data associated with a latency sensitive service. Latency improvements may be achieved with a limited expansion in bandwidth, rather than doubling the spectrum that is used.

System 100 may be configured such that the MLDs 104 and 106 have multiple channels where one channel is smaller than other channels. In a two-channel system, a first channel may be smaller than a second channel. The first channel may be associated with a first link pair (e.g., TX first link 202, RX first link 212) and the second channel may be associated with a second link pair (e.g., TX second link 204, RX second link 214). In a specific example, the first channel may include a 20 MHz channel and the second channel may include an 80 MHz channel. Any number of links and channels and widths may be used.

In the system 200, latency sensitive data (and/or latency sensitive services) may be mapped to both channels. All available links may be available for latency sensitive data and/or latency sensitive services. For example, a transmitter (e.g., the first MLD 104) can assign either the 20 MHz or 80 MHz channel for a latency sensitive service. The channel assignment may occur, in some embodiments, on a per-packet basis. The transmitter may also map non-latency sensitive services to the 80 MHz channel only.

As illustrated, data 220 may be associated with a latency sensitive service. Data 220 may include data packets 220a, 220b, 220c, 220d, and 220e. Data 230 may be associated with a non-latency sensitive service.

The first MLD 104 may assign all of the data 230 (e.g., packets 230a, 230b, 230c, 230d) to a larger bandwidth channel (e.g., 80 MHz) that is mapped to the TX second link 204. The first MLD 104 may assign most of the data 220 to a smaller bandwidth channel (e.g., 20 MHz) that is mapped to the TX first link 202. The assignment of the data 220 to the TX first link 202 may be for any reason, including the TX second link 204 is already busy and is transmitting the data 230. To avoid waiting for the TX second link 204 to become available, the data 220, which is latency sensitive, may be transmitted using the TX first link 202. As illustrated, data packets 220a, 220b, 220c and 220e and transmitted over the smaller bandwidth channel and data packet 220d is transmitted over the larger bandwidth channel. This transmission of the data packet 220d over the larger bandwidth channel may be done for any reason, including an availability of the larger bandwidth channel and/or TX second link 204, a busy state of the smaller bandwidth channel and/or the TX first link 202, a detected interference level or spike, etc.

The first MLD 104 may select a particular channel for use with latency sensitive data, including in response to a determination of interference among all available channels. For example, in a 320 MHz bandwidth, there may be 16 available 20 MHz channels. The first MLD 104 may identify an interference level for each of the 16 available 20 MHz channels and may select the channel with the lowest amount of interference. Additionally or alternatively, the first MLD 104 may identify an interference level of one channel and if the interference level is below a threshold interference amount, the first MLD 104 may select that channel for use with latency sensitive data and/or services.

The first MLD may periodically obtain interference levels for the smaller bandwidth channel to determine if an interference on the smaller bandwidth channel exceeds a predetermined interference threshold level. If the interference on the smaller bandwidth channel exceeds the predetermined interference threshold level, the first MLD can select a different channel to use as the smaller bandwidth channel, which selection may include a process similar to any process used to select the smaller bandwidth channel in the first instance.

Using such a system 200 for data transmission using a smaller bandwidth channel and a larger bandwidth channel may provide significant advantages. The smaller bandwidth channel may be reserved for latency sensitive traffic and the larger bandwidth channel may include both non-latency sensitive traffic and latency sensitive traffic, where the latency sensitive traffic scheduled in the larger bandwidth channel may include a smaller frame (e.g., less data and/or traffic) as the latency sensitive traffic may be transmitted over the smaller bandwidth channel more frequently. In some embodiments, the smaller bandwidth channel may experience less interference between traffic which may contribute to latency sensitive traffic experiencing less delays in transmissions. In some embodiments, traffic transmitted over the smaller bandwidth channel (e.g., the latency sensitive channel) may be transmitted in parallel with traffic transmitted over the larger bandwidth channel (e.g., the combined latency and non-latency sensitive channel).

As compared to conventional systems, the service associated with the data 220 has more transmission opportunities overall. Rather than being “stuck” behind other transmissions (e.g., behind data 230), the targeted service associated with the data 220 can now be sent in parallel over the 20 MHz channel (which is reserved specifically for this purpose and only occasionally needs to yield to another transmission), even if the bandwidth of that second link is much lower than the first link.

Using the system 200, the latency of the latency sensitive service that is handled using the smaller bandwidth channel is virtually independent of a network load. In some embodiments, a load on the smaller bandwidth channel and associated link is assumed to be a fixed amount (e.g., 10%), while a load on the larger bandwidth channel and associated link is varied between 0 and 80%. The relatively static or fixed amount of load on the smaller bandwidth channel is partly due to that channel being reserved for latency sensitive data and/or latency sensitive services.

Modifications, additions, or omissions may be made to the system 200 without departing from the scope of the present disclosure. For example, any number of MLDs may be used. Further, any number of links (e.g., links 206, 216) may be present on the MLDs. Moreover, as described, the first MLD 104 is described as a transmitter and the second MLD 106 is described as a receiver. Those roles may be reversed and the first MLD 104 may operate as a receiver and the second MLD 106 may operate as a transmitter. Other modifications, additions, or omissions may be made to the system 200 without departing from the scope of the present disclosure. For example, in some embodiments, the system 200 may include any number of other components that may not be explicitly illustrated or described.

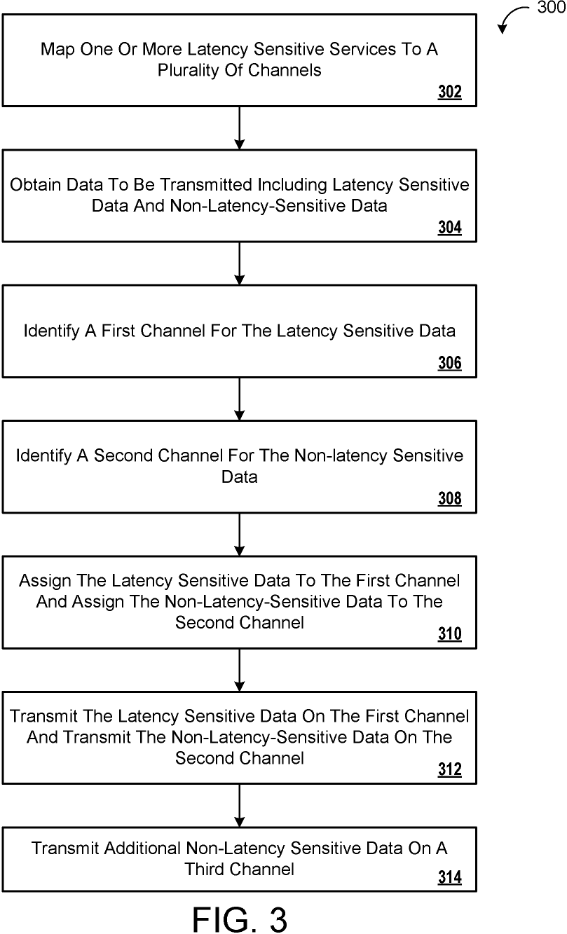

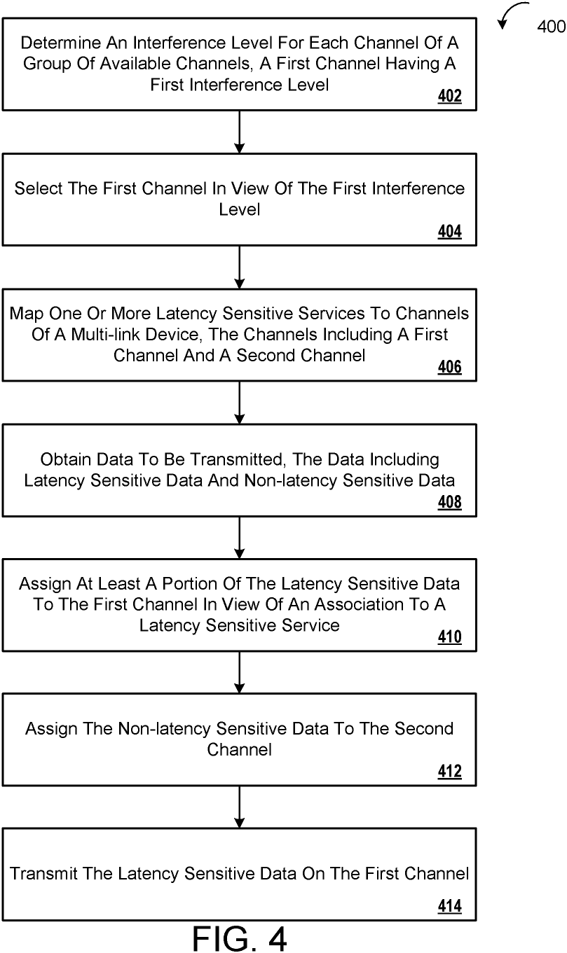

FIGS. 3-4 illustrate flowcharts of an example arrangements of operations for methods for latency reduction in MLD systems and while using multiple radio links (e.g., 2.4 GHz, 5 GHz, 6 GHz). The methods may be performed by processing logic that may include hardware (circuitry, dedicated logic, etc.), software (such as is run on computer system or a dedicated machine), or a combination of both, which processing logic may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

Referring to FIG. 3, a method 300, at operation 302, includes mapping one or more latency sensitive services to multiple channels, including to a first channel and to a second channel. The first channel and the second channel may be different widths. The first channel may be a smaller width than the second channel, such as 20 MHz and the second channel may be 40 MHz, 80 MHz, 160 MHz, etc. More specifically, the first channel may be 20 MHz and the second channel may be 80 MHz. In some embodiments, a total available width for channels is at least 320 MHz. The first channel may be associated with a first link of a multi-link device and the second channel may be associated with a second link of the multi-link device.

The method 300, at operation 304, includes obtaining data to be transmitted. The data may include latency sensitive data and non-latency sensitive data. The latency sensitive data may be received from a same source as the non-latency sensitive data or from a different source.

The method 300, at operation 306, includes identifying a first channel of the multiple channels for the latency sensitive data. The method 300, at operation 308, includes identifying a second channel of the multiple channels for the non-latency sensitive data.

The method 300, at operation 310, includes transmitting the latency sensitive data on the first channel; and the method 300, at operation 312, includes transmitting the non-latency sensitive data on the second channel.

The method 300, at operation 314, includes transmitting additional non-latency sensitive data on a third channel.

Referring to FIG. 4, a method 400, at operation 402, includes determining an interference level of a first channel. Additionally, the method may include determining an interference level for each channel of a group of available channels.

The method 400, at operation 404, includes selecting the first channel in view of the first interference level. In some embodiments, the first channel is selected in view of an amount of interference on the first channel being below an interference threshold.

The method 400, at operation 406, includes mapping one or more latency sensitive services to multiple channels of a multi-link device. The multiple channels including the first channel and a second channel. In some embodiment, the first channel is selected to map from a group of available channels by determining an interference level for each channel of the group of available channels the first channel having a first interference level and selecting the first channel in view of the first interference level being lower than each other interference level for each channel of the group of available channels.

The method 400, at operation 408, includes obtaining data to be transmitted, the data including latency sensitive data and non-latency sensitive data. At least some of the data may be associated with a latency sensitive service of the one or more latency sensitive services.

The method 400, at operation 410, includes assigning at least a portion of the latency sensitive data to the first channel in view of an association to a latency sensitive service. The latency sensitive data may be assigned to the first channel on a per-packet basis. In some embodiments, assigning the at least a portion of the latency sensitive data to the first channel includes assigning a first packet of the latency sensitive data to the first channel and assigning a second packet of the latency sensitive data to the second channel. The method 400, at operation 412, includes assigning the non-latency sensitive data to the second channel.

The method 400, at operation 414, includes transmitting the latency sensitive data on the first channel. The non-latency sensitive data may be transmitted on the second channel, or on any channel other than the first channel.

FIG. 5 is a schematic view illustrating a machine in the example form of a computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 500 includes a processing device (e.g., a processor) 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

Processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over a network 518 via the network interface device 522.

While the computer-readable storage medium 526 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In an example, a multi-link device may include a memory and one or more processors operatively coupled to the memory. The one or more processors may be configured to execute operations including to obtain data to be transmitted, the data including latency sensitive data and non-latency sensitive data, assign at least a portion of the latency sensitive data to a first channel, and assign non-latency sensitive data to a second channel, the first channel having a smaller width than the second channel. The example multi-link device may include a first link and a second link, where the first channel is associated with the first link of the multi-link device, where the second channel is associated with the second link of the multi-link device. The example multi-link device may be configured to operate in a 320 MHz or greater system. The example multi-link device may include first channel being assigned based on an interference measurement related to the first channel.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method, comprising:
mapping one or more latency sensitive services to a plurality of channels;
obtaining data to be transmitted, the data including latency sensitive data and non-latency sensitive data;
identifying a first channel of the plurality of channels for the latency sensitive data;
identifying a second channel of the plurality of channels for the non-latency sensitive data;
transmitting the latency sensitive data on the first channel; and
transmitting the non-latency sensitive data on the second channel.

2. The method of claim 1, wherein the first channel and the second channel are different widths.

3. The method of claim 2, wherein the first channel is a smaller width than the second channel.

4. The method of claim 2, wherein the first channel is 20 MHz and the second channel is at least 80 MHz.

5. The method of claim 1, wherein the first channel is associated with a first link of a multi-link device, wherein the second channel is associated with a second link of the multi-link device.

6. The method of claim 1 further comprising transmitting additional non-latency sensitive data on a third channel.

7. The method of claim 1, wherein a total available width for channels is at least 320 MHz.

8. A method, comprising:
mapping one or more latency sensitive services to a plurality of channels of a multi-link device, the plurality of channels including a first channel and a second channel;
obtaining data to be transmitted, the data including latency sensitive data and non-latency sensitive data, at least some of the data being associated with a latency sensitive service of the one or more latency sensitive services;
assigning at least a portion of the latency sensitive data to the first channel in view of an association to a latency sensitive service; and
assigning the non-latency sensitive data to the second channel.

9. The method of claim 8, wherein the latency sensitive data is assigned to the first channel on a per-packet basis.

10. The method of claim 8, wherein assigning the at least a portion of the latency sensitive data to the first channel includes:
assigning a first packet of the latency sensitive data to the first channel; and
assigning a second packet of the latency sensitive data to the second channel.

11. The method of claim 8, wherein the first channel is selected in view of an amount of interference on the first channel being below an interference threshold.

12. The method of claim 8, wherein the first channel is selected to map from a group of available channels by:
determining an interference level for each channel of the group of available channels the first channel having a first interference level; and
selecting the first channel in view of the first interference level being lower than each other interference level for each channel of the group of available channels.

13. The method of claim 8, wherein the first channel and the second channel are different widths.

14. The method of claim 13, wherein the first channel is a smaller width than the second channel.

15. The method of claim 13, wherein the first channel is 20 MHz and the second channel is at least 80 MHz.

16. The method of claim 8, wherein the first channel is associated with a first link of a multi-link device, wherein the second channel is associated with a second link of a multi-link device.

17. A multi-link device, comprising:
a memory; and
one or more processors operatively coupled to the memory, the one or more processors being configured to execute operations comprising:
obtain data to be transmitted, the data including latency sensitive data and non-latency sensitive data;
assign at least a portion of the latency sensitive data to a first channel; and
assign non-latency sensitive data to a second channel, the first channel having a smaller width than the second channel.

18. The multi-link device of claim 17, further comprising a first link and a second link, wherein the first channel is associated with the first link of the multi-link device, wherein the second channel is associated with the second link of the multi-link device.

19. The multi-link device of claim 17, the multi-link device being configured to operate in a 320 MHz or greater system.

20. The multi-link device of claim 17, the first channel being assigned based on an interference measurement related to the first channel.
